(19) United States
(12) Patent Application Publication
(10) Pub. No.: US 2008/0022919 A1
(43) Pub. Date: Jan. 31, 2008

(54) Selective marking

(76) Inventors: Thomas S. Ohnstad, Salem, OR (US); Micah T. Goettl, Albany, OR (US); Chad J. Knowles, Wilsonville, OR (US)

Correspondence Address: ROBERT D. VARITZ, P.C., 4915 SE 33RD PLACE, PORTLAND, OR, 97202, US

(21) Appl. No.: 11/725,894

(22) Filed: Mar. 19, 2007

Related U.S. Application Data
(60) Provisional application No. 60/791,233, filed on Apr. 7, 2006.
(60) Provisional application No. 60/799,622, filed on May 10, 2006.

(51) Int. Cl. G08B 7/00; G08B 5/00

(52) U.S. Cl. 116/201; 340/573.1

(57) ABSTRACT

A non-lethal method for the identification-marking of a culpability-action culprit involving, at substantially the time of culprit participation in such an action, marking/tagging that culprit with a detectable, non-lethal, tenacity marking medium which is designed to stay tenaciously resident with the culprit, and which, because of its detectability, can readily pinpoint a marked culprit. Such tagging preferably involves enveloping the culprit with a vapor-like cloud of such a medium, whereby the medium enters at least one of the culprit's (a) clothing, (b) skin, and (c) anatomical orifices. This methodology also importantly enables the attendant location and identification of culprit collaborators by using the occasion of finding a specifically tagged culprit to observe the company kept by that culprit.

### CROSS-REFERENCE TO RELATED APPLICATIONS

This application claims respective priorities to two currently co-pending U.S. Provisional Patent Applications. These applications, the entire disclosure contents in which are hereby incorporated by reference, include Ser. No. 60/791,233, filed Apr. 7, 2006, for “Selective Marking”, and Ser. No. 60/799,622, filed May 10, 2006, for “Selective Marking”.

### BACKGROUND AND SUMMARY OF THE INVENTION

This invention relates to selective, and normally clandestine, non-lethal, tenacious marking of what is referred to herein as a defined-action, or culpability-action, culprit. In particular, it relates to identification-marking of such a culprit in a manner which is essentially unavoidable and undefeatable by the culprit, and which allows for relatively long-term, distance-detectable identification of such a culprit, and additionally of culprit-collaborators (i.e., the company kept by a marked culprit), to enable capture and “decommissioning/neutralizing” of such people. As will be seen, the invention focuses attention on a unique methodology for successfully “tagging” an otherwise difficult to “stop, and capture-in the-act” culprit who engages in various kinds of undesirable behaviors. As will also be seen, identification-marking of even just an individual culprit in accordance with practice of this invention, where that culprit is engaged in culpable activities also involving associates/collaborators, furnishes a unique way of finding and also “decommissioning” of those other parties.

A culprit herein is an individual, and/or an individual and an associated “assist” vehicle (or other “assist” structure), who/which has engaged in a defined, aggressive, dangerous, criminal, pseudo-criminal, law-avoiding, or other similar undesirable/culpable act, and who must be found and “stopped/put out of business”.

The invention also contemplates, and addresses the fact and condition, that a specific-action culprit, in certain instances, may have remote collaborators, each and all of whom is/are desired to be identified and similarly “stopped”.

An attention-getting situation (series of events) which has played an important, though not solo, role in spurring the birth of the present invention involves the life-devastating “culprit” military/insurgency use, in a currently active combat theatre in the Middle East, of devices called IED (Improvised Explosive Device) devices. The deploying of such a device is referred to herein as one illustrative form of a culprit-implemented event, or action, and the location where such an event or action takes place, or is intended by a culprit to take place, is referred to herein as an event environment.

Other illustrative events and event environments involve, without limitation, matters such as criminal-suspect surveillance, crime watch activities, police SWAT-team actions, civil disturbance occurrences, on-prison-site and off-prison-site “prisoner” monitoring, and many others.

While several specific marking modalities, i.e., marking-substance-applying modalities, which have been found to be especially useful in certain illustrative types of culpability activities and events that are mentioned herein, are set forth in modest detail in the description of the present invention's practice which is presented below, various other kinds of marking modalities, perhaps more appropriately useable in relation to “other” kinds of “culprit-activities”, will become readily apparent to those generally skilled in the relevant art, and are not elaborated in this text. The specific details of marking-delivery modalities are thus not considered to be central to the practice of the methodology of this invention.

As will be learned from the discussion presented below, along with the accompanying drawings, the invention proposes, for various defined events and event environments like those just mentioned above, a unique and very effective, easily and remotely detectable, non-lethal, and substantially culprit-unavoidable and culprit-undefeatable, methodology for performing easily spotted, relatively long-term culprit-identification-marking, or tagging, which, in many instances, is at least partially culprit-undetectable, and therefore clandestine, and which can lead not only to direct culprit detection and apprehension, but also to detection and apprehension of culprit collaborators.

### DESCRIPTION OF THE DRAWINGS

FIG. 1 illustrates, in a very simplified and schematic form, the basic concept of non-lethal identification-marking/tagging generally of a human culprit in accordance with a preferred and best mode manner of implementing the invention. Two, different, specific modes of marking, or tagging, a culprit are generally pictured in this figure.

FIG. 2, also styled in a simplified and schematic manner, depicts a precursor stage of culprit-identification-marking in the setting of a roadway-pothole environment (an event environment) where a culprit is about to place an IED device (a defined-action, or event) in an illustrated pot-hole which has been specially prepared, in accordance with practice of the invention, to mark this culprit via triggered, explosive release of a vaporous cloud, or mist, of one or more culprit-identification-marking substance(s).

FIG. 3 schematically pictures practice of the invention to identification-mark a culprit-assist vehicle with an adhesively-adhereable, GPS-equipped, electronic RF announcing device.

The contents of these drawing figures are not necessarily drawn to scale.

### DETAILED DESCRIPTION OF THE INVENTION

For the purpose of illustrating and describing a preferred and best mode manner of practicing the present invention, the invention description herein is presented principally in relation to a particular type of military situation wherein it has been found to offer special utility. This illustrative situation involves the culprit-placing (referred to herein, as just mentioned above, as an event, or a defined culprit action, which takes place in an event environment) of an IED device typically in or at a relatively innocuous-looking and unsuspected IED ground site, such as in a pot-hole in a road, embedded in a chunk of litter alongside a roadway, or linked what looks like an ordinary discarded “junk” item, and so on.

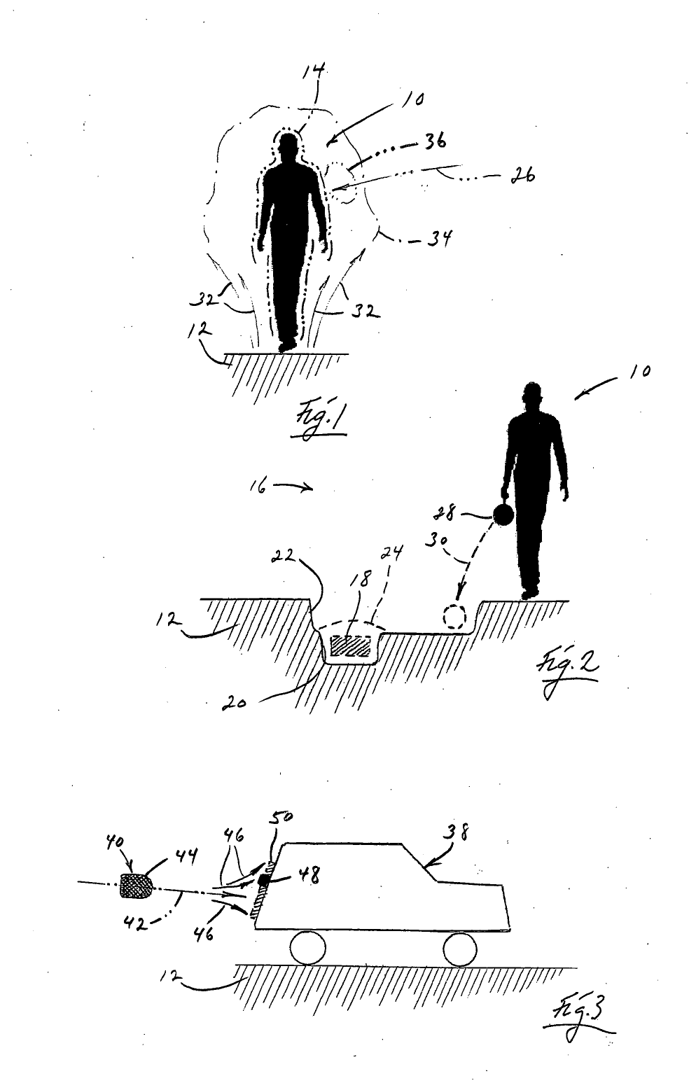

In FIG. 1, a culprit 10—a man—who is shown walking on a roadway 12, is illustrated in a condition wherein he has been identification-marked, as is illustrated by the surrounding dash-double-dot, body-enveloping outline 14, with a tenacious (i.e., substantially non-sheddable), non-lethal, relatively long-lasting (preferably at least a week or so), remotely and outwardly detectable, identification-marking substance (or plural “blended” substances) in accordance with a selected-mode preferred practice of the present invention. This condition of marking-medium-substance-marking, the application of which medium is illustrated generally in FIG. 1 in two different successful manners, or modes, of implementation as will shortly be explained, is such that the employed marking medium effectively permeates/attaches-to the culprit's skin, to his clothing, and, among other ways, to and within various exposed orifices, such as the nostrils, etc.

Adding reference now to FIG. 2 along with FIG. 1, we will assume, for the purpose of further explaining what FIG. 1 shows about ways, or modes, (two are illustrated) of practicing the present invention, that culprit 10 has just been present in what is referred to herein as an event environment, such as the event environment shown generally at 16 in FIG. 2, wherein he was about to engage in, or did just engage in, culprit activity (i.e., a culprit action, or event, as referred to herein) regarding which he has been appropriately marked.

While there are various ways in which culprit marking in such an environment can be practiced, the two quite useful ways specifically illustrated in FIG. 1 involving an IED setting include (a) the use of a triggerable (by remote-monitored activation, by specific-characteristic sound, by specific-characteristic vibration, by specific-characteristic motion, etc.), non-lethal explosive device, such as device 18 (seen in FIG. 2) which is, for example, deployed in a prepared cavity 20 in an existing roadway pot-hole 22 in roadway 12, and concealed by a suitable camouflage mask 24, and (b) the striking of a culprit by a remotely fired (as by a 40-mm shoulder-fire weapon), non-lethal, fragmentation, marking-medium-carrying projectile, as is suggested by the slightly downwardly curving, dash-triple-dot arrow 26 in FIG. 2. The culprit activity calling for identification-marking in the military situation pictured in FIG. 2 involves the prospective (or actually completed) placement by culprit 10 of a triggerable IED device 28 in pot-hole 22, as suggested by dashed-line arrow 30.

Explosive marking is represented in FIG. 1 by upwardly, and oppositely laterally outwardly, curving arrows 32, coupled with dash-dot cloud outline 34 which represents the development of an ensuing, blanketing vapor/mist, or cloud, of marking medium (preferably about 8-feet in “diameter”). Striking, fragmentation-projectile marking is represented in FIG. 1 by the fragmentation-produced “puff” of marking medium suggested by dash-triple-dot line 36, coupled also with ensuing vapor/mist blanketing as suggested by dash-dot cloud outline 34.

With respect to explosive device marking, such a device may be software-enabled to perform intelligent assessment of an appropriate triggering condition. For example, it may make suitable “normal-ambient-condition” readings of sound, vibration, and/or visible motion in order to be able accurately to distinguish culprit behavior. It may also be equipped to produce a retrievable time-stamp of a detonation to perform marking, and might also be equipped with a tiny video system able to capture culprit imagery.

In terms of implementing the practice of the present invention in the military setting now being used for illustration purposes herein, pot-hole 22 in roadway 12 has preferably been chosen as a “culprit-entrapment” candidate site because it looks like a good location for the anticipated placement by a culprit of an IED device. In relation to this site, therefore, the invention contemplates the selection and clandestine use of it as a “culprit-trapping” event site. In other words, the site of pot-hole 22 is to be employed herein for the purpose of luring a would-be IED culprit to place there an IED device, such as previously mentioned device 28, and in the process of that “placing” event, to become identification-marked in accordance with practice of the invention. Actually, in a military setting, such as the one now being described, it will be the normal practice of military personnel to select and establish a large plurality of differently located culprit-enticement-and-trapping IED sites.

Other kinds of “sites” which might, as illustrations, be considered include false rocks, planted water bottles, a planted soft-drink can, a false layer of apparent asphalt, etc. These kinds of sites might also be chosen for the independent placements of culprit sensors which functionally “watch” for culprit activities adjacent, potential, anticipated IED-placement locations. Yet another potential kind of culprit-marking site could include an existing IED-created crater.

From the description just given above regarding setting a trap for a culprit in the world of IED devices, it should be clear that, while the selection and use of a pot-hole style entrapment site has been used herein for illustration purposes, the “field” for creating, and/or selecting, and using such a site need only be limited by one's creative imagination.

It should be understood that, and as was stated earlier herein, the present invention does not involve the specific design or designs chosen for non-lethal explosive marking delivery, or for impact-fragmentation-projectile marking delivery. Persons skilled in those relevant arts will well understand how to generate suitable structures for those particular delivery modalities. With regard to the many non-IED kinds of events where practice of the present invention has important utility, several of which kinds of events have been identified above in this text, those skilled in the art will readily perceive how to achieve appropriate marking-media applications to the relevant categories of associated action culprits.

The ultimate intent associated with practice of the present invention is to mark, capture and “decommission” a culprit—human and/or otherwise—and to employ an identification-marking approach which produces, preferably, distance-detectable, relatively long-term marking which, after the marking event, promotes culprit location, and hopefully location also of any associated “culprit-collaborators”. In the IED setting, and specifically where human-culprit marking is involved in that setting, the marking event preferably should be traumatic, and should produce intimidation—a fearful recognition y a culprit that something “bad” has just happened—something which could perhaps have been much worse—a shock which masks the fact that what has in fact occurred has been the critical (for later permanent culprit decommissioning) act of identification-marking—an act which is effectively unavoidable by a culprit, and (at least initially) undetectable thereby.

Preferably, also, the planned and executed marking experience should be timed in such a manner, and be disruptive enough, that the “culprit-event”, or “defined culprit action”, such as the setting of an IED device, becomes thwarted.

Respecting substance, or medium, marking per se, the invention contemplates several important substance-use approaches, with respect to which selected tenacity marking substances may be employed (i.e., applied to a culprit) either singly or in pluralities. The following, representative human marking media, or marking substances and/or approaches, are contemplated.
(1) Vapor-detectable. A scent-producing, vapor-broadcasting, vapor-detectable medium, such as any one of various known substances which can be detected variously by a suitably trained search dog, by a specialized, vapor-sensitive machine, and even by a readily and appropriately trained swarm of bees. Such a medium is (a) preferably culprit-applied in such a way that it permeates, or attaches to, both clothing and skin, (b) relatively long-lasting, and distance-detectable, and (c) not easily neutralized (i.e., not easily sheddable or maskable), and with the vapor from this medium also preferably not necessarily being humanly detectable. Representative substances for such a medium which come to mind include white willow bark and acetaminophen.
(2) Capable of Producing a Visibility Mark. A visibility-producing substance, including a substance, or more than one substance, which is/are normally non-visible but which is/are triggerable by contact with moisture, or, for example, by selected, remotely-activated illumination, such as any one of a number of known colored dyes, powders, vapor mists, etc., characterized with either (a) normal human-optical visibility, (b) normally non-visible IR-illumination presentability, (c) normally non-visible UV-illumination presentability, or (d) otherwise (if normally non-visible) remotely triggerable to a condition of visibility. Such “visibility-marking” substances are also ones which are deliverable as suggested above for vapor-detectable substances, and which also have relatively long-lasting, “non-sheddable”, etc. qualities.
Representative substances include the product known as Crystal Violet, P/N (Part Number) 1-2725, made by Armor Forensics in Jacksonville, Fla., and the luminescent powder product sold as P/N NGX-19, made by Day Glo Color Corporation in Cleveland, Ohio.
(3) Anatomical Irritant. A substance, or several combined substances, such as (a) milled fiberglass, (b) essence of poison oak or poison ivy, (c) low levels of sulfuric, nitric or citric acid, (d) nano-particulate size cocklebur and (e) cyanine pepper, which attach(es) to and/or permeate(s) the skin to produce a relatively long-lasting and quite evident anatomical irritation which may, in turn, produce highly visible irritant-ridding activity. Where essence of poison ivy is employed, this substance may well act as an ingredient which is capable of producing, as between a marked culprit and any culpable associates/collaborators, person-to-person spreading, thus to act effectively as a agency for finding such associates/collaborators.

As mentioned earlier herein, plural marking media/substances, or markers, in the same or differing categories of marking media/substances, may be employed in combination if desired. Where plural markers are indeed employed, one or so of these markers might purposely be chosen to be a decidedly culprit-detectable “decoy”, thus to conceal the fact that at least one other, non-culprit-detectable marker is in place, whereby culprit efforts to mask, defeat or eliminate detected marking become focused in vain on the decoy marker(s).

Marking substances of the types discussed above may be prepared and delivered to produce detectable evidence of marking, for example, when the marked party, say, engages with an external substance such as water during hand-washing or bathing. Applied marking substances may also become tenaciously “attached” through natural interaction with culprit body moisture and/or oils. Substances which become effective in a condition of skin permeation may be made to permeate the skin with substantial assistance by blending them with a suitable, non-harmful, human-transdermal infusing agent, such as the substance well known as DMSO.

Additionally contemplated by the present invention is that certain marking substances may selectively be employed which are so noticeable as attention-getters that a culprit's friends/collaborators visibly and very detectably shy away from the marked party, thus offering one convenient way of both locating the directly marked culprit party, and in the bargain identifying potential collaborators.

In the context of the above suggested-use marking substances, one very successful “blend” of plural substances has proven to be a mix of about 5-10% milled fiberglass, about 30% luminescent colored powder (such as that identified above), about 60% purple-violet dye (such as the dye identified illustratively above), and about 5% white willow bark powder.

It is also useful to note that different specific marking substances, or blends thereof, may be chosen with specific differentiation in mind so as to become indicative of specific different “culprit locations” where marking takes place.

Turning attention now to FIG. 3, this figure illustrates a situation wherein a culprit-assist structure, such as vehicle 38, is employed for culprit transportation assistance. In accordance with a modified form of practicing the present invention, independent identification-marking (for remote tracking) of such a structure (the vehicle in this illustrative instance) is employable, as by the launching/firing of a suitable, non-lethal fragmentation projectile 40, as indicated by dash-double-dot arrow 42, which projectile strikes the vehicle, and, designed with suitable, forward, outer fragmentation packaging 44, breaks open (see curved arrows 46) to release a GPS-structure-possessing, radio-frequency (RF)-capable transmission device, or instrumentality, 48 that becomes bonded tenaciously, and preferably not easily-noticeably, and as by a suitable and very robust, conventional structure-adhering adhesive substance 50, to the vehicle, and/or perhaps a blend of such an adhesive and a strong magnetic powder. Device 48 is also referred to herein as an electronic announcing device which, because of possessing GPS structure, can readily report its geographic location. This approach, of course, allows for easy vehicle tracking, and where coupled with the added practice of personal culprit marking, per se, as above described, furnishes a very effective way to find the relevant culprit, and his or her home base of operation, including, probably, any culpable associates and collaborators.

Thus, the present invention offers a number of unique, non-lethal approaches, for identifying, ultimately for later “decommissioning”, what have been described herein as culpability-action culprits.

Accordingly, one manner of describing this invention is to characterize it as a non-lethal method for the identification-marking of a culpability-action culprit involving, at substantially the time of culprit participation in such an action, tagging that culprit with a detectable, non-lethal, tenacity marking medium which is designed to stay tenaciously resident with the culprit.

Another way of visualizing the invention is to describe it as a non-lethal method for the identification-marking of a defined-action culprit involving, at substantially the time of culprit participation in such an action, tagging that culprit with a detectable, non-lethal, tenacity marking medium which is designed to stay tenaciously resident with the culprit for an extended period of post-action-participation time, and to do so in a substantially non-sheddable, outwardly-detectable condition.

Still another way of characterizing the invention is to see it as being a non-lethal method for the identification-marking of a culpability-action culprit for subsequent location involving, (a) at a time of culprit participation in culpability action, tagging that culprit with a detectable, non-lethal, tenacity marking medium which is designed to stay tenaciously resident with the culprit, and (b) following such tagging, employing the tagging marking medium as a device for the subsequent finding of the tagged culprit.

Yet a further descriptive way of seeing the methodology of this invention is to view it as being a non-lethal method for the identification-marking of a culpability-action culprit for subsequent location of that culprit, and for attendant location and identification of culprit collaborators, with this method including (a) at a time of culprit participation in culpability action, tagging that culprit with a detectable, non-lethal, tenacity marking medium which is designed to stay tenaciously resident with the culprit, (b) following such tagging, employing the tagging marking medium as a device for the subsequent finding of the tagged culprit, and (c) on, and in relation to, an occasion of such a finding, observing the company kept by the tagged culprit.

These and other modified ways of expressing and implementing the invention are recognized to be entirely possible, and perceivable by those generally skilled in the art, and are considered to be well within the spirits and scopes of the herein associated claims to invention.

I claim:

1. A non-lethal method for identification-marking of a culpability-action culprit comprising
at substantially the time of culprit participation in such an action, tagging that culprit with a detectable, non-lethal, tenacity marking medium which is designed to stay tenaciously resident with the culprit.

2. A non-lethal method for identification-marking of a defined-action culprit comprising
at substantially the time of culprit participation in such an action, tagging that culprit with a detectable, non-lethal, tenacity marking medium which is designed to stay tenaciously resident with the culprit for an extended period of post-action-participation time, and to do so in a substantially non-sheddable, outwardly-detectable condition.

3. The method of claim 2, wherein said tagging includes applying to the culprit a marking medium which is vapor-detectable.

4. The method of claim 2, wherein said tagging includes applying to the culprit a marking medium which produces a visibility mark borne by the culprit.

5. The method of claim 4, wherein said applying to produce a visibility mark involves using a normally non-visible marking medium which is triggerable to a condition of visibility by selected, remotely-activated illumination.

6. The method of claim 2, wherein said tagging includes applying to the culprit a marking medium in the form of at least one human anatomical irritant.

7. The method of claim 6, wherein said applying involves using such an included irritant which is of a category that prompts at least one kind of visible irritant-ridding activity.

8. The method of claim 2, wherein said tagging involves using, in conjunction with the mentioned marking medium, a non-harmful, human-transdermal infusing agent.

9. The method of claim 8, wherein said using involves employing DMSO as the mentioned infusing agent.

10. The method of claim 2, wherein said tagging includes using a marking medium which possesses at least one ingredient which is capable of producing person-to-person spreading.

11. The method of claim 2, wherein said tagging includes applying to the culprit a marking medium characterized by a plural marking-substance make-up.

12. The method of claim 2, wherein said tagging involves marking a culprit-assist structure with a marking substance that includes an electronic announcing device.

13. The method of claim 12, wherein said electronic announcing device is an RF-capable instrumentality, and possesses GPS structure capable of enabling RF-reporting of device geographic position.

14. The method of claim 12, wherein said tagging involves firing/launching a non-lethal projectile characterized with fragmentation packaging which carries the electronic announcing device along with a structure-adhering substance, and which shatters upon impact to deploy that announcing device along with the adhering substance.

15. A non-lethal method for identification-marking of a culpability-action culprit for subsequent location comprising
at a time of culprit participation in culpability action, tagging that culprit with a detectable, non-lethal, tenacity marking medium which is designed to stay tenaciously resident with the culprit, and
following said tagging, employing the tagging marking medium as a device for the subsequent finding of the tagged culprit.

16. The method of claim 15, wherein said tagging involves enveloping the culprit with a vapor-like cloud of such a marking medium whereby the medium enters at least one of the (a) culprit's clothing, (b) the culprit's skin, and (c) the culprit's anatomical orifices.

17. A non-lethal method for identification-marking of a culpability-action culprit for subsequent location of that culprit, and for attendant location and identification of culprit collaborators, said method comprising
at a time of culprit participation in culpability action, tagging that culprit with a detectable, non-lethal, tenacity marking medium which is designed to stay tenaciously resident with the culprit,
following said tagging, employing the tagging marking medium as a device for the subsequent finding of the tagged culprit, and
on, and in relation to, an occasion of such a finding, observing the company kept by the tagged culprit.

18. The method of claim 17, wherein said tagging involves enveloping the culprit with a vapor-like cloud of such a marking medium, whereby the medium enters at least one of the (a) culprit's clothing, (b) the culprit's skin, and (c) the culprit's anatomical orifices.

19. The method of claim 17, wherein said tagging includes using a marking medium which possesses at least one ingredient which is capable of producing person-to-person spreading.
